(19) United States
(12) Patent Application Publication
(10) Pub. No.: US 2016/0154900 A1
(43) Pub. Date: Jun. 2, 2016

(54) 3D MODEL COMPONENT COMPARING SYSTEM AND METHOD THEREOF

(71) Applicants: INVENTEC (PUDONG) TECHNOLOGY CORPORATION, Shanghai City (CN); INVENTEC CORPORATION, Taipei City (TW)

(72) Inventors: CHUNG-SHENG NI, Taipei City (TW); CHIH-PIN WEI, Taipei City (TW); CHANG-HSIN CHIU, Taipei City (TW); CHUN-YING YANG, Taipei City (TW)

(21) Appl. No.: 14/793,122

(22) Filed: Jul. 7, 2015

(30) Foreign Application Priority Data
Nov. 27, 2014 (CN) 201410697139.6

(51) Int. Cl. G06F 17/50

(52) U.S. Cl. CPC G06F 17/50

(57) ABSTRACT

A 3D model component comparing system and method thereof are provided. The 3D model component comparing system includes a model-capturing unit, a processing unit, and a message-prompting unit. The model-capturing unit obtains a first model and a second model in a model design interface. The processing unit compares a plurality of components of the first model and a plurality of components of the second model to obtain a plurality of components which have different names, and analyzes them to determine whether the plurality of components which have different names have identical component data correspondingly or not. The message-prompting unit outputs a renaming prompting message if the plurality of components, which have different names, have identical component data correspondingly. Thus the design error rate is reduced.

### CROSS-REFERENCE TO RELATED APPLICATIONS

This non-provisional application claims priority under 35 U.S.C. §119(a) on Patent Application No. 201410697139.6 filed in China on Nov. 27, 2014, the entire contents of which are hereby incorporated by reference.

### BACKGROUND OF THE INVENTION

1. Technical Field of the Invention

The present invention relates to a system and a method for assisting model design, particularly to a 3D component comparing system and method thereof.

2. Description of the Related Art

As the advancement of the modern technology, various commercial products are brought to the market, and the structures of the products are getting more and more complex. Therefore, the time and costs of the product design become important keys in association with the success in the market.

Product design usually relies on the participation of various personnel of different areas, and the coordination between people is a big challenge during the design process. For example, the designer does not grasp the detailed modifications between different versions during the design resulting in unnecessary mistakes and modifications, and the costs of product design are increased.

Additionally, a tiny modification of any component between different design versions may cost a lot of time and human resources for the comparison in advance when the complexity of the product structure increases, so that the design can be moved to the next stage. However, the comparison process usually lacks of a precise method and can only rely on the experiences of product designer and the observation of a naked eye.

### SUMMARY OF THE INVENTION

A 3D model component comparing system having a model design interface includes a model capturing unit, a processing unit, and a message-prompting unit. The model-capturing unit is for capturing a first model and a second model in the model design interface. The processing unit is coupled to the model-capturing unit and is for comparing a plurality of components of the first model with a plurality of components of the second model, and obtaining a plurality of components with different names from the plurality of components of the first model and the plurality of components of the second model, and analyzing whether the plurality of components with different names have at least one identical component datum correspondingly. The message-prompting unit is coupled to the processing unit and is for outputting a renaming prompting message when the plurality of components with different names have identical component data correspondingly among the plurality of components of the first model and the plurality of components of the second model.

In an embodiment, the processing unit is for reading an information weight priority in the model design interface and for sequentially analyzing the plurality of components with different names according to the information weight priority to obtain the component data of the plurality of components with different names.

In an embodiment, the information weight priority is set according to a component material, a component weight, a component geometric center, and an assigned parameter of the component.

In an embodiment, the processing unit is for analyzing the plurality of components with different names in the first model and the second model, and when the component data of one of the plurality of components with different names in the first model are totally different from the component data of any of the plurality of components with different names in the second model, the message prompting unit sends a deletion prompting message. When the component data of one of the plurality of components with different names in the second model is totally different from the component data of any of the plurality of components with different names in the first model, the message-prompting unit sends a adding prompting message.

In an embodiment, the component data is selected from the group consisting of a component material, a component weight, a component geometric center, an assigned parameter of the component, and a combination thereof.

A 3D model component comparing method for a 3D model component comparing system having a model design interface includes capturing a first model and a second model in the model design interface. It also compares a plurality of components of the first model with a plurality of components of the second model to obtain a plurality of components with different names from the plurality of components of the first model and the plurality of components of the second model. It will analyze whether the plurality of components with different names have at least one identical component datum correspondingly, outputting a renaming prompting message when the plurality of components with different names have identical component data correspondingly, and stop analyzing when the plurality of components with different names have different component data.

In an embodiment, the step of analyzing whether the plurality of components with different names have at least one identical component datum further includes reading an information weight priority in the model design interface, and sequentially analyzing the plurality of components with different names according to the information weight priority to obtain the component data of the plurality of components with different names.

In an embodiment, the information weight priority is set according to a component material, a component weight, a component geometric center, and an assigned parameter of the component.

In an embodiment, the 3D model component comparing method further includes analyzing the plurality of components with different names of the first model and the plurality of components with different names of the second model. When the component data of one of the plurality of components with different names of the first model are totally different from the component data of any of the plurality of components with different names of the second model, it will a deletion prompting message. When the component data of one of the plurality of components with different names of the second model are totally different from the component data of any of the plurality of components with different names of the first model, it will send an adding prompting message.

In an embodiment, the component data is selected from the group consisting of a component material, a component weight, a component geometric center, an assigned parameter of the component, and a combination thereof.

### BRIEF DESCRIPTION OF THE DRAWINGS

The present invention will become more fully understood from the detailed description given herein below and the accompanying drawings, which are given by way of illustration only and thus are not limitative of the present invention and wherein:

FIG. 1 is a block diagram of the 3D model component comparing system according to an embodiment;

FIG. 2 is a flowchart of the 3D model component comparing method according to an embodiment;

FIG. 3 is a diagram of a plurality of components of the first model and the second model displayed in the model design interface according to an embodiment; and

FIG. 4 is a flowchart of the 3D model component comparing method according to another embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

When a product designer wants to proceed to the next stage during the product design process, he has to figure out the commonality or difference between different design versions in order to ensure the correctness of the design. However, the product designer possibly makes mistakes during the product design process because components with different names but essentially with identical characteristics exist in different design versions. Therefore, the solution is specifically explained hereinafter.

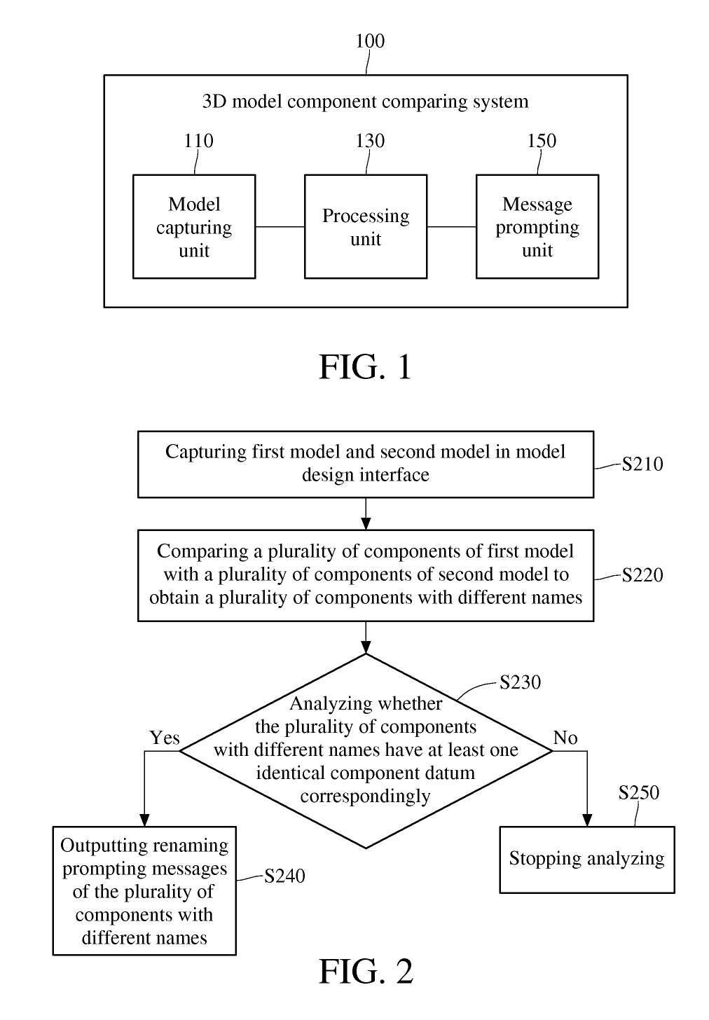

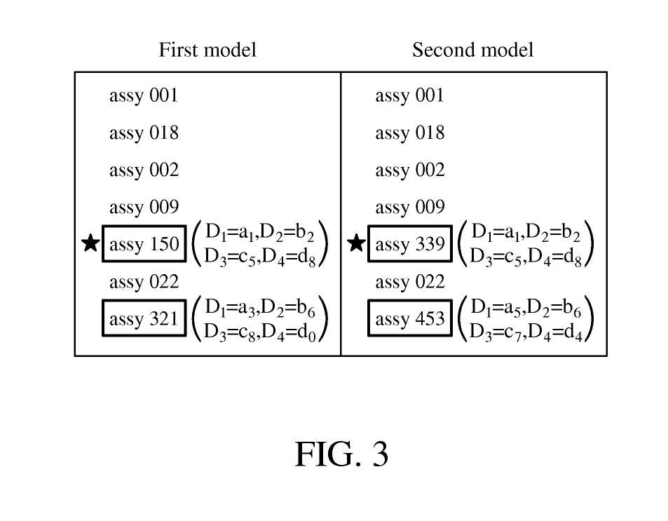

FIG. 1 is a block diagram of the 3D model component comparing system according to an embodiment. FIG. 2 is a flowchart of the 3D model component comparing method according to an embodiment. FIG. 3 is a diagram of a plurality of components of the first model and the second model displayed in the model design interface according to an embodiment.

As shown in FIG. 1, 3D model component comparing system 100 includes a model-capturing unit 110, a processing unit 130, and a message-prompting unit 150. The processing unit 130 is coupled to the model-capturing unit 110 and the message-prompting unit 150 is coupled to the processing unit 130. In the present embodiment, the model-capturing unit 110, the processing unit 130 and the message-prompting unit 150 are but not limited to various microprocessors or chips. As shown in FIG. 2, the 3D model component comparing method according to the present embodiment includes the steps S210˜S250. Please refer to FIG. 1, FIG. 2 and FIG. 3 together as follows.

First, in the step S210, the product designer captures the first model and the second model from the model design interface provided by the model-capturing unit 110. The first model and the second model are product models in different design versions during the product design process. For example, the first model is a prototype of the product provided by the upstream firms, and the second model is a modified product model after the downstream clients reviewed the prototype. In another example, the first model is a first-stage product model designed by the product designer A in the design team, and the second model is a second-stage product model designed by designer B based on the first-stage product model. The first model and the second model respectively have a plurality of components, and each of the plurality of components has a component name and a plurality of component data. The component name is the name named by the product designer, and the plurality of component data of the component stand for the essential characteristics of the component. In the present embodiment, the component datum is a component material, a component weight, a component geometric center, an assigned parameter of the component, or a combination of the previous data. The assigned parameter is, but not limited to, the color of the component or other component parameter. The product designer possibly gives different names to two components with identical characteristics during the product design process.

After the first model and the second model are captured in the model design interface, in step S220, the processing unit 130 continuously compares the plurality of components of the first model with the plurality of components of the second model to obtain a plurality of components with different names. As shown in FIG. 3, the first model includes the components assy001, assy018, assy002, assy009, assy150, assy022, and assy321, and the second model includes the components assy001, assy018, assy002, assy009, assy339, assy022, and assy453. The processing unit 130 finds out the first components assy150, assy321 in the first model whose names are different from any name of the component in the second model, and finds out the second components assy339, assy453 in the second model whose names are different from any name of the component in the first model. The processing unit 130 eliminates the components with identical names in the first model and the second model, and further finds out the first components assy150, assy321 with different names or the second components assy339, assy453 with different names.

Next, in step S230, the processing unit 130 analyzes whether at least one identical component datum exists among the plurality of components with different names. For example, the processing unit 130 pairwisely compares the component data between the first components with different names and the second components with different names, wherein the first components with different names are assy150 and assy321, and the second components with different names are assy339 and assy453, and the component data stand for the material D1, the weight D2, the geometric center D3, and the assigned parameter D4. In FIG. 3, the processing unit 130 determines that the names of the assy150 and the assy339 are different but the plurality of component data of the two components are identical, that is, D1=a1, D2=b2, D3=c5, and D4=d8.

Next, in step S240, when a plurality of components with different names correspondingly have identical component data, the message-prompting unit 150 outputs a renaming prompting message. For example, as shown in FIG. 3, the method of outputting the renaming prompting message by the message prompting unit 150 is marking the first component with a different name assy150 and the second component with a different name assy339 which correspondingly have a plurality of identical component data with stars in the component list of the first model and the component list of the second model in the model design interface. In another embodiment, the method of outputting the renaming prompting message by the message-prompting unit 150 is listing the first components and the second components, which correspondingly have a plurality of identical component data one by one in an extra independent list. In a further embodiment, the method of outputting the renaming prompting message by the message-prompting unit 150 is respectively marking the first components with different names and the second components with different names which correspondingly have a plurality of identical component data in the blueprint of the first model and the second model in the model design interface. Therefore, the message-prompting unit 150 outputs the renaming prompting message with various methods and the aforementioned embodiments are for illustrating but not for limiting the present invention. In step S250, when the plurality of components with different names don't have identical component data, the processing unit 130 stops the analysis.

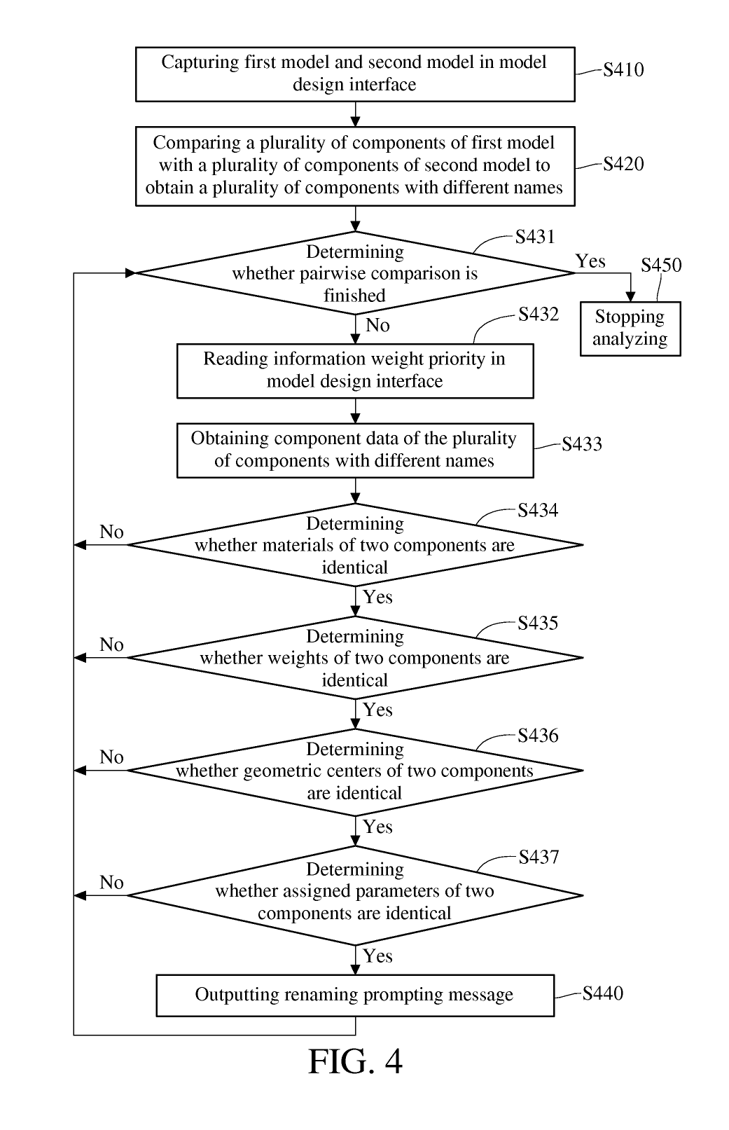

FIG. 4 is a flowchart of the 3D model component comparing method according to another embodiment. As shown in FIG. 4, the 3D model component comparing method in an embodiment includes the steps S410, S420, S431˜S437, S440 and S450. Please refer to FIG. 1, FIG. 3, and FIG. 4 together as follows.

As the aforementioned explanation, in the step S410, the product designer captures the first model and the second model in the model design interface provided by the model-capturing unit 110. In step S420, the processing unit 130 compares a plurality of components of the first model with a plurality of components of the second model to obtain a plurality of components with different names from the plurality of components of the first model and the plurality of components of the second model. As said above, the processing unit 130 finds out the first components assy150, assy321 with different names in the first model and finds out the second components assy339, assy453 with different names in the second model.

Next, in step S431, the processing unit 130 determines whether the pairwise comparison between the first components with different names and the second components with different names is finished. When the comparison is not finished yet, the step S432 is executed. When the comparison is finished, step S450 is executed to stop the analysis.

In step S432, the processing unit 130 reads the information weight priority in the model design interface, wherein the information weight priority is set according to the component material, the component weight, the component geometric center, and the assigned parameter of the component. In step S433, the processing unit 130 obtains the component data of the plurality of components with different names. Specifically, the processing unit 130 respectively reads a plurality of component data of a component from the first components with different names and the second components with different names. For example, component data are read from the first component with a different name assy150 and the second component with a different name assy339.

In step S434, the processing unit 130 determines whether the materials of the two components read from the first component and the second component are identical. When the materials of the two components are identical, the step S435 is further executed. When the materials of the two components are different, the process goes back to the step S431. For example, when the processing unit 130 compares the material D1 of assy150 with the material D1 of assy339 and determines that the material D1 of assy150 and the material D1 of assy339 are both a1, the S435 is executed.

In step S435, the processing unit 130 determines whether the weights of two read components are identical. When the weights of the two components are identical, step S436 is further executed. When the weights of the two components are different, the process goes back to step S431. For example, the processing unit 130 compares the weight D2 of assy150 with the weight D2 of assy339 and determines that the weight D2 of assy150 and the weight D2 of assy339 are both b2, step S436 is executed.

In step S436, the processing unit 130 determines whether the geometric centers of two read components are identical. When the geometric centers of the two components are identical, step S437 is further executed. When the geometric centers of the two components are different, the process goes back to step S431. For example, the processing unit 130 compares the geometric center D3 of assy150 with the geometric center D3 of assy339 and determines that the geometric center D3 of assy150 and the geometric center D3 of assy339 are both c5, then step S437 is executed.

In step S437, the processing unit 130 determines whether the assigned parameters of two read components are identical. When the assigned parameters of the two components are identical, step S440 is further executed. When the assigned parameters of the two components are different, the process goes back to the step S431. For example, the processing unit 130 compares the assigned parameter D4 of assy150 with the assigned parameter D4 of assy339 and determines that the assigned parameter D4 of assy150 and the assigned parameter D4 of assy339 are both d8, the step S440 is executed.

In step S440, when the plurality of components with different names correspondingly have identical component data, the message prompting unit 150 outputs the renaming prompting message, and repeatedly executes step S431 until the comparison is finished and the analysis is stopped.

In an embodiment, the comparison order of the material, the weight, the geometric center, and the assigned parameter of the component data in steps S434, S435, S436, and S437 are respectively arranged according to the priority of each of the component data. For example, in the plurality of component data, the material has the highest priority, and the weight has the second highest priority, and the geometric center has the third highest priority, and the assigned parameter has the lowest priority. Therefore, the comparison order of the component data is material, weight, geometric center, and assigned parameter. Additionally, arranging the comparison order according to the priority of the component data speeds up the comparison process.

In an embodiment, the first model is a first-stage product model designed by the product designer A in the design team, and the second model is a second-stage product model designed by designer B based on the first-stage product model. The processing unit 120 analyzes the plurality of components with different names in the first model and the second model. When the component data of one of the plurality of components with different names in the first model is totally different from the component data of any of the plurality of components with different names in the second model, the message-prompting unit 150 sends a deletion-prompting message. In other words, when the processing unit 120 determines that the plurality of component data of one of the plurality of first components with different names are totally different from the plurality of component data of any of the plurality of second components with different names, the components in the first model do not further exist in the second model after the possibility of modifying the component name is eliminated. Therefore, the deletion-prompting message is sent through the message-prompting unit 130 to notify the product designer that the identical components are eliminated in the second model comparing to the first model, such as assy321 in FIG. 3. Similarly, when the component data of one of the plurality of components with different names in the second model is totally different from the component data of any of the plurality of components with different names in the first model, the message-prompting unit 150 sends a new adding prompting message. In other words, when the processing unit 120 determines that the plurality of component data of one of the plurality of second components with different names is totally different from the plurality of component data of any of the plurality of first components with different names, the components in the second model do not further exist in the first model after the possibility of modifying the component name is eliminated. Therefore, the adding prompting message is sent through the message-prompting unit 130 to notify the product designer that a component is newly added in the second model comparing to the first model, such as assy453 in FIG. 3.

In an embodiment, the model capturing unit captures the first model and the second model in the model design interface, and the processing unit finds out the components in the first model whose names are different from any of the names of the components in the second model and the components in the second model whose names are different from any of the names of the components in the first model, and pairwisely compares the first components with different names with the second components with different names according to the order of the component data priority to determine whether any component with identical component data of material, weight, geometric center, and assigned parameter exists among the first components with different names with the second components with different names. If yes, the renaming prompting message is outputted through the message-prompting unit. Additionally, when the component data of a component among the first components with different names is totally different from the component data of any of the second components with different names, a deletion-prompting message is sent. When the component data of a component of the second components with different names is totally different from the component data of any of the first components with different names, an adding prompting message is sent. Therefore, mastery of modifying the internal components resulting from the modified design version to the product designer is enhanced and the design error rate by multiple designers is reduced, so that unnecessary design mistakes and modifications are avoided and the design costs are further reduced.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. A 3D model component comparing system having a model design interface, the 3D model component comparing system comprising:
a model-capturing unit for capturing a first model and a second model in the model design interface;
a processing unit coupled to the model-capturing unit, for comparing a plurality of components of the first model with a plurality of components of the second model, and obtaining a plurality of components with different names from the plurality of components of the first model and the plurality of components of the second model, and analyzing whether the plurality of components with different names have at least one identical component datum correspondingly; and
a message-prompting unit coupled to the processing unit, for outputting a renaming prompting message when the plurality of components with different names have identical component data correspondingly among the plurality of components of the first model and the plurality of components of the second model.

2. The 3D model component comparing system of claim 1, wherein the processing unit is for reading an information weight priority in the model design interface and for sequentially analyzing the plurality of components with different names according to the information weight priority to obtain the component data of the plurality of components with different names.

3. The 3D model component comparing system of claim 2, wherein the information weight priority is set according to a component material, a component weight, a component geometric center, and an assigned parameter of the component.

4. The 3D model component comparing system of claim 1, wherein the processing unit is used to analyze the plurality of components with different names in the first model and the second model, and when the component data of one of the plurality of components with different names in the first model are totally different from the component data of any of the plurality of components with different names in the second model, the message-prompting unit sends a deletion prompting message, and when the component data of one of the plurality of components with different names in the second model is totally different from the component data of any of the plurality of components with different names in the first model, the message prompting unit sends an adding prompting message.

5. The 3D model component comparing system of claim 1, wherein the component datum is selected from the group consisting of a component material, a component weight, a component geometric center, an assigned parameter of the component, and a combination thereof.

6. A 3D model component comparing method for a 3D model component comparing system, the 3D model component comparing system having a model design interface, the 3D model component comparing method comprising:
capturing a first model and a second model in the model design interface;
comparing a plurality of components of the first model with a plurality of components of the second model to obtain a plurality of components with different names from the plurality of components of the first model and the plurality of components of the second model;
analyzing whether the plurality of components with different names have at least one identical component datum correspondingly;
outputting a renaming prompting message when the plurality of components with different names have identical component data correspondingly; and
stopping analyzing when the plurality of components with different names have different component data.

7. The 3D model component comparing method of claim 6, wherein the step of analyzing whether the plurality of components with different names have at least one identical component datum further comprises:
reading an information weight priority in the model design interface; and
analyzing the plurality of components with different names according to the information weight priority sequentially, to obtain the component data of the plurality of components with different names.

8. The 3D model component comparing method of claim 7, wherein the information weight priority is set according to a component material, a component weight, a component geometric center, and an assigned parameter of the component.

9. The 3D model component comparing method of claim 6, further comprising:
analyzing the plurality of components with different names of the first model and the plurality of components with different names of the second model;
when the component data of one of the plurality of components with different names of the first model is totally different from the component data of any of the plurality of components with different names of the second model, sending a deletion prompting message; and
when the component data of one of the plurality of components with different names of the second model and any of the component data of the plurality of components with different names of the first model are different, then sending an adding prompting message.

10. The 3D model component comparing method of claim 6, wherein the component datum is selected from the group consisting of a component material, a component weight, a component geometric center, an assigned parameter of the component, and a combination thereof.
